(19) United States
(12) Patent Application Publication
(10) Pub. No.: US 2009/0002498 A1
(43) Pub. Date: Jan. 1, 2009

(54) Wind Noise Reduction Apparatus, Audio Signal Recording Apparatus And Imaging Apparatus

(75) Inventor: Tomoki OKU, Osaka City (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Moriguchi City (JP)

(21) Appl. No.: 12/100,047

(22) Filed: Apr. 9, 2008

(30) Foreign Application Priority Data
Apr. 13, 2007 (JP) JP2007-105795

(51) Int. Cl. H04N 5/225; H04B 15/00

(52) U.S. Cl. 348/207.99; 381/94.1; 381/94.3; 348/E05.024

(57) ABSTRACT

Provided that α is a wind noise reduction filter factor derived by a wind noise analyzer, filtering units 5 and 6 use α as an exponent and raise the levels of frequency-base signals Ln(f) and Rn(f) to the αth power to thereby produce and output the signals Ln′(f) and Rn′(f), respectively.

### CROSS REFERENCE TO RELATED APPLICATION

Applicant claims, under 35 U.S.C. .sctn. 119, the benefit of priority of the filing date of Apr. 13, 2007, of a Japanese Patent Application No. P 2007-105795, filed on the aforementioned date, the entire contents of which are incorporated herein by reference.

### BACKGROUND OF THE INVENTION

1. Field of the Invention

The present invention relates to technologies for reduction of noise produced by the wind, which is contained in an audio signal when the audio signal is picked up by an audio signal pickup unit such as a microphone.

2. Description of the Related Art

The sound of the wind (hereinafter called “wind noise”) contained in an audio signal picked up by a microphone (hereinafter called a “stereo microphone”) capable of picking up audio signals from the left and the right independently of each other is known to possess the following two properties.

(1) There is little correlation between the wind noise from the left and the wind noise from the right, picked up by the stereo microphone.

(2) The wind noise tends to concentrate in the low to mid frequency range (i.e., at frequencies from 50 Hz to 1 kHz).

Thus, heretofore, wind noise reduction has often involved the use of a HPF. The HPF is used to detect wind noise based on the correlation value between the wind noise inputted from the left and the wind noise inputted from the right, and to reduce the detected wind noise.

Incidentally, the audio signals from the left and the right picked up by the stereo microphone will be hereinafter called an “L signal” and an “R signal,” respectively.

FIG. 1 is a block diagram of a conventional wind noise reduction apparatus.

Referring to FIG. 1, a wind noise decision unit 101 determines whether or not wind noise is produced. If the wind noise is produced, HPFs 102 and 103 suppress low-frequency signals, of input audio signals, containing the wind noise.

Specifically, when a wind noise reduction apparatus 100 receives inputs of an L signal (l(t)) and an R signal (r(t)), the wind noise decision unit 101 calculates the correlation value between the L signal (l(t)) and the R signal (r(t)), and makes a determination as to whether or not wind noise is produced, based on the correlation value. If a determination is made that the wind noise is produced, the HPFs 102 and 103 are brought into operation. This achieves attenuation of the magnitude (or intensity) of audio signals in a low frequency band, containing the wind noise.

On the other hand, if a determination is made that the wind noise is not produced, the HPFs 102 and 103 are not brought into operation.

Therefore, when receiving an L signal (l(t)) and an R signal (r(t)) containing the wind noise, the wind noise reduction apparatus 100 outputs respectively an L signal (l′(t)) and an R signal (r′(t)) having the wind noise suppressed. On the other hand, when receiving an L signal (l(t)) and an R signal (r(t)) not containing the wind noise, the wind noise reduction apparatus 100 outputs respectively the L signal (l(t)) and the R signal (r(t)) as the L signal (l′(t)) and the R signal (r′(t)) without noise suppression.

Japanese Patent Application Publication No. 2003-187216 discloses a wind noise reduction technology as mentioned above.

### SUMMARY OF THE INVENTION

A wind noise reduction apparatus according to the present invention is the wind noise reduction apparatus that reduces wind noise contained in each of plural audio signals by performing filtering on the plural audio signals. The wind noise reduction apparatus includes a wind noise analyzer that derives a variable P (0<P≦1) corresponding to the degree of correlation between at least two of the plural audio signals, and a filtering unit configured to perform the filtering. The filtering unit raises a function of frequency components of each of the plural audio signals to the Pth power. Here, the function of the frequency components of the audio signals includes any one of multiplication that is performed by multiplying the frequency components of the audio signals by a predetermined value, and addition that is performed by adding a predetermined value to the frequency components of the audio signals, or the like.

In the wind noise reduction apparatus according to the present invention, the wind noise analyzer may derive the variable P so that the variable P becomes larger as the degree of the correlation becomes higher.

Also, in the wind noise reduction apparatus according to the present invention, the wind noise analyzer may include a decision unit configured to make a determination as to whether or not the wind noise is produced, based on the degree of the correlation, and the wind noise analyzer may set the variable P to a predetermined value less than 1 if the decision unit determines that the wind noise is produced, or set the variable P to 1 if the decision unit determines that the wind noise is not produced.

Also, in the wind noise reduction apparatus according to the present invention, the filtering unit may perform the filtering on frequencies lower than a predetermined frequency in an audio-frequency band.

An audio signal recording apparatus according to the present invention is the audio signal recording apparatus that reduces wind noise contained in each of plural audio signals by performing filtering on the plural audio signals. The audio signal recording apparatus according to the present invention includes a plurality of audio signal pickup units configured to pick up the plurality of audio signals, and a wind noise analyzer configured to derive a variable P (0<P≦1) corresponding to the degree of correlation between at least two of the plurality of audio signals, and a filtering unit configured to perform the filtering. The filtering unit configured to perform the filtering raises frequency components of each of the plural audio signals to the Pth power.

Also, the audio signal recording apparatus according to the present invention may further include a display unit configured to display a wind noise mark indicative of information on the wind noise according to the value of the variable P derived by the wind noise analyzer.

An imaging apparatus according to the present invention includes an image pickup unit configured to pick up an image of a subject; and the above-described audio signal recording apparatus.

### BRIEF DESCRIPTION OF THE DRAWINGS

FIG. 1 is a general block diagram of the conventional wind noise reduction apparatus.

FIG. 2 is a general block diagram of a wind noise reduction apparatus according to an embodiment of the present invention.

FIG. 3 is a general block diagram of a wind noise reduction apparatus according to another embodiment of the present invention.

FIGS. 4A to 4D are diagrams explaining a wind noise reduction process, which is performed by a conventional wind noise reduction apparatus.

FIGS. 5A to 5C are diagrams explaining wind noise reduction according to the embodiment of the present invention.

FIG. 6 is a graph of assistance in explaining the wind noise reduction according to the embodiment of the present invention.

FIGS. 7A and 7B are general block diagrams of an imaging apparatus and an audio signal recording apparatus, respectively, in which the present invention is implemented.

FIG. 8 is a block diagram of an AAC encoder.

FIGS. 9A to 9D are illustrations showing a display unit on which the degree of wind noise is displayed.

### DETAILED DESCRIPTION OF EMBODIMENTS

### Embodiments

Embodiments of the present invention will be described specifically below with reference to the drawings. The following description is just one embodiment of the present invention, and definition of terms of constituent features is not limited by the following description. In the following description of the drawings, the same or similar reference numerals are given to the same or similar components, and overlapping descriptions about the same or similar components are skipped, in principle.

FIG. 2 is a block diagram (or a functional block diagram) of a wind noise reduction apparatus according to one embodiment of the present invention.

As employed herein, ln(t) and rn(t) refer to an L signal and an R signal, respectively, which are expressed as functions of time t, (hereinafter called “time-base signals”).

Time-base transform units 2 and 3 transform the time-base signals ln(t) and rn(t) into Ln(i) and Rn(f), respectively, which are expressed as functions of frequency f, (hereinafter called “frequency-base signals”), for example by performing DFT (discrete Fourier transform), MDCT (modified discrete cosine transform), or the like. For example, 2048 sampled time-base signals ln(t) and rn(t) are transformed through the MDCT into 1024 sampled frequency-base signals Ln(f) and Rn(f), respectively, which in turn are subjected to filtering by filtering units 5 and 6, respectively, to be described later.

A wind noise analyzer 4 derives a parameter for wind noise reduction (hereinafter called a “wind noise reduction filter factor”), based on the L signal and the R signal.

As mentioned above, the wind noise has little correlation between the L signal and the R signal. For example, therefore, the wind noise analyzer 4 calculates the correlation value between the frequency-base signals Ln(f) and Rn(f) of the L and R signals, and derives the wind noise reduction filter factor based on the correlation value.

The filtering units 5 and 6 subject Ln(f) and Rn(f) to wind noise reduction using the wind noise reduction filter factor derived by the wind noise analyzer 4, to thereby produce frequency-base signals Ln′(f) and Rn′(f), respectively, which in turn are outputted.

Specifically, the filtering units 5 and 6 raise the levels of the frequency-base signals Ln(f) and Rn(f) to the αth power to thereby produce the levels of the signals Ln′(f) and Rn′(f), respectively, which in turn are outputted, provided that a is the wind noise reduction filter factor derived by the wind noise analyzer 4 and α is used as an exponent.

In other words, Equations (1) and (2) are used to generate Ln′(f) and Rn′(f), respectively.

Ln′(ƒ)=Ln(ƒ)^{α} (1)

Rn′(ƒ)=Rn(ƒ)^{α} (2)

Frequency-base transform units 7 and 8 inversely transform Ln′(f) and Rn′(f) outputted by the filtering units 5 and 6 into time-base signals ln′(t) and rn′(t), respectively, for example by performing IDFT (inverse discrete Fourier transform) or IMDCT (inverse modified discrete cosine transform), and then output the signals ln′(t) and rn′(t), respectively.

Description will now be given in further detail with regard to the function of the wind noise analyzer 4.

For example, the wind noise analyzer 4 calculates the average of correlation values between the 1024 sampled frequency-base signals Ln(f) and Rn(f), and uses the calculated average as the value K of the correlation between the L signal and the R signal. For example, Equation (3) is used for calculation of the correlation value K.

$$K = ( {\sum }_{f = 0}^{1024} \frac{Rn ( f ) * L n ( f )}{{Rn ( f )}^{2} + L {n ( f )}^{2}} ) / 1024 \qquad ( 3 )$$

According to Equation (3), K is the value that lies between 0 and 1, both inclusive (0≦K≦1).

The wind noise analyzer 4 derives the wind noise reduction filter factor a based on the correlation value K.

Also, the wind noise analyzer 4 may determine whether or not the correlation value K is larger than a predetermined threshold value C, for detection of the presence or absence of the wind noise.

Specifically, if the correlation value K is equal to or smaller than the threshold value C (K≦C), a determination is made that there is no correlation between the L signal and the R signal, or equivalently, the wind noise is produced.

The correlation value K satisfies (0≦K≦1) as mentioned above, and 0.5 is an intermediate value; however, the threshold value C may be empirically set to satisfy (0.5≦C≦0.8) to determine whether or not the wind noise is produced, which is appropriate for human audibility.

In this instance, the wind noise analyzer 4 sets a to a predetermined value so that α satisfies (0<α<1).

On the other hand, if the correlation value K is larger than the threshold value C (K>C), a determination is made that the wind noise is not produced, and α is set equal to 1 (α=1).

Also, the wind noise analyzer 4 may set a for the derivation thereof so that α satisfies, for example, (0<α≦1) and so that α varies in gradually increasing relation as the value K of the correlation between the L signal and the R signal becomes larger, while a varies in gradually decreasing relation as the correlation value K becomes smaller.

Alternatively, the wind noise analyzer 4 may be configured for the detection of the presence or absence of the wind noise and also for the derivation of the wind noise reduction filter factor α only in the presence of the wind noise, based on the correlation value K as mentioned above.

Also, α may be set equal to 1 (α=1) for application of Equations (1) and (2), for an audio signal having a midrange or higher frequency f of, for example, 1 kHz or higher, allowing for the fact that the wind noise tends to concentrate in the low to mid frequency range (i.e., at frequencies from 50 Hz to 1 kHz) as mentioned above.

Alternatively, α may be controlled so that α increases as the frequency f increases varying from the low-frequency range to the high-frequency range.

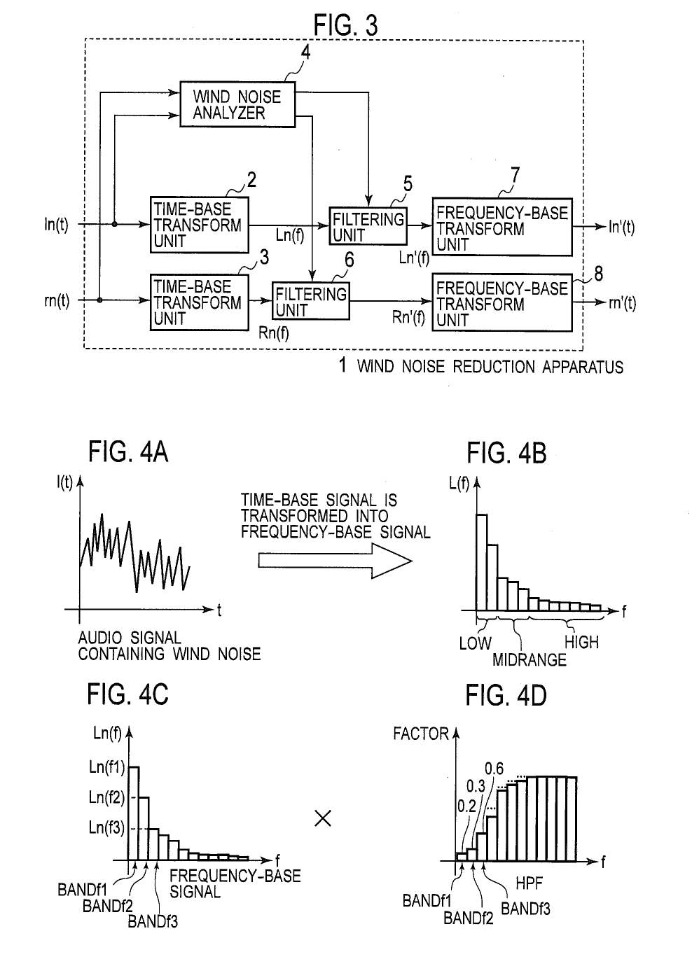

Incidentally, the wind noise analyzer 4 may calculate the correlation value between the time-base signals ln(t) and rn(t) yet to be transformed into the frequency-base signals as shown in FIG. 3, although the wind noise analyzer 4 calculates the correlation value between the frequency-base signals Ln(f) and Rn(f) as shown for example in FIG. 2.

According to Equations (1) and (2), the exponent a satisfies (0<α<1), and thus, any one of the filtering units 5 and 6 outputs any one of Ln(f) and Rn(f) at any one of the same and reduced levels.

Discussion will now be made, for example assuming that α is fixedly set equal to 0.8 (α=0.8). Equations (1) and (2) are exponential functions of Ln(f) and Rn(f), respectively, and thus, the degree of attenuation through any one of the filtering units 5 and 6 becomes greater as any one of the levels of Ln(f) and Rn(f) becomes higher. Conversely, the degree of attenuation becomes smaller as any one of the levels of Ln(f) and Rn(f) becomes lower.

Therefore, if a sharp increase in the levels of audio signals in a certain band fa of low frequencies, for example, is caused by the wind noise of very great magnitude due to the occurrence of a gust of wind or the like, Equations (1) and (2) are used for significant reduction in the levels of the audio signals in the frequency band fa. In this instance, almost all the audio signals, the levels of which have increased sharply, can be judged as the wind noise, and thus, Equations (1) and (2) can be used for significant reduction in the wind noise.

On the other hand, if the levels of the audio signals in the frequency band fa increase somewhat due to the wind noise of small magnitude, the use of Equations (1) and (2) does not effect much reduction in the levels of the audio signals in the frequency band fa. In this instance, the audio signals in the frequency band fa can be judged as not having a low ratio of the magnitude of the essentially required audio signal to the magnitude of the wind noise, and thus, Equations (1) and (2) can be used to achieve the wind noise reduction to some extent and also prevent the attenuation of the essentially required audio signal.

Also, as mentioned above, α is set equal to 1 (α=1) for a midrange or higher frequency band, or alternatively, α is controlled so that α increases as the frequency band changes from the low-frequency range to the high-frequency range, and thereby, even if the wind noise is produced, the setting or control enables avoiding, wherever possible, the occurrence of a situation where the use of Equations (1) and (2) leads to a reduction in the levels of audio signals in the midrange or higher frequency band, which are not affected much by the wind noise.

Incidentally, in the above-mentioned embodiment, the L signal and the R signal are used as input audio signals; however, three or more microphones may be feasibly used in the same manner.

Specifically, the wind noise has little correlation of one with another of the microphones, and thus, input audio signals from any two of the microphones are brought into correspondence with ln(t) and rn(t), respectively, as shown in FIG. 2. Then, input audio signals from all microphones are subjected to processes by any one of the time-base transform units 2 and 3, any one of the filtering units 5 and 6, and any one of the frequency-base transform units 7 and 8. These processes render feasible even with the use of three or more microphones.

### First Example

In the above-mentioned embodiment, the wind noise reduction filter factor α is fixedly set equal to 0.8 (α=0.8), for example. Then, the wind noise analyzer 4 is configured only for the detection of the presence or absence of the wind noise, based on the correlation value between the L signal and the R signal. Specifically, if the value K calculated by use of Equation (3) is larger than the preset threshold value C, the wind noise analyzer 4 determines that the wind noise is not produced, and outputs a control signal indicative of the determined result to the filtering units 5 and 6.

If the wind noise analyzer 4 determines that the wind noise is not produced, the filtering units 5 and 6 output the input signals Ln(f) and Rn(f), as they are, as the signals Ln′(f) and Rn′(f), respectively. In other words, this is the equivalent of processing that is performed when a is set equal to 1 (α=1) for the application of Equations (1) and (2).

On the other hand, if the value K is equal to or smaller than the threshold value C, the wind noise analyzer 4 determines that the wind noise is produced, and outputs a control signal indicative of the determined result to the filtering units 5 and 6.

If the wind noise analyzer 4 determines that the wind noise is produced, the filtering units 5 and 6 raise Ln(f) and Rn(f) to the power of 0.8 to thereby produce Ln′(f) and Rn′(f), respectively, which in turn are outputted.

Also, since the wind noise tends to concentrate in the low to mid frequency range (i.e., at frequencies from 50 Hz to 1 kHz), the filtering units 5 and 6 output Ln(f) and Rn(f), as they are, as Ln′(f) and Rn′(f), respectively, for a signal having a frequency f of 1 kHz or higher, even if the wind noise is produced. In other words, this is the equivalent of the processing that is performed when α is set equal to 1 (α=1) for the application of Equations (1) and (2).

In other words, the filtering units 5 and 6 subject Ln(f) and Rn(f) to wind noise reduction processing using Equations (4), (5), (6) and (7) to thereby produce Ln′(f) and Rn′(f), respectively, which in turn are outputted.

Either if the wind noise is absent (K>C) or if the frequency f is equal to or higher than 1 kHz (ƒ≧1 kHz), Equations (4) and (5) are applied.

Ln′(ƒ)=Ln(ƒ) (4)

Rn′(ƒ)=Rn(ƒ) (5)

Both if the wind noise is present (K≦C) and if the frequency f is lower than 1 kHz (ƒ<1 kHz), Equations (6) and (7) are applied.

Ln′(ƒ)=Ln (ƒ)^{0.8} (6)

Rn′(ƒ)=Rn (ƒ)^{0.8} (7)

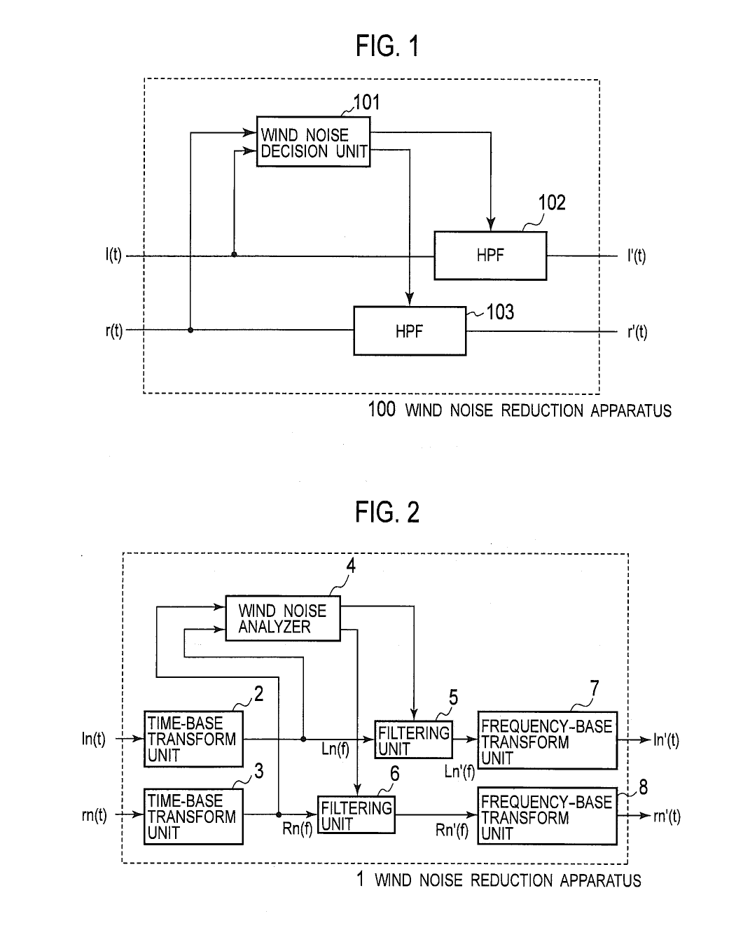

Description will be given below with regard to differences in processing and effect between the conventional wind noise reduction apparatus 100 shown in FIG. 1 and a wind noise reduction apparatus 1 according to the first example.

Incidentally, description will be given below only for the L signal, since the L signal and the R signal are subjected to the same processing.

FIG. 4A shows a schematic representation of the L signal as the time-base signal. FIG. 4B shows the frequency-base signal into which the time-base signal shown in FIG. 4A is transformed.

FIGS. 4C and 4D are diagrams for explaining which frequency-base processing is equivalent to the time-base HPF processing by the conventional wind noise reduction apparatus 100. Incidentally, the same L signal is given for FIGS. 4B and 4C.

Referring to FIGS. 3C and 3D, bands f1 and f2 are low frequency bands of less than 1 kHz, and a band f3 is a midrange frequency band of 1 kHz or more.

FIG. 4D shows a frequency-base filter factor for each frequency band of the HPF 102 shown in FIG. 1.

In the conventional wind noise reduction apparatus 100, as mentioned above, if the wind noise decision unit 101 determines that the wind noise is present, the HPF 102 performs the HPF processing on the L signal. The HPF processing is equivalent to multiplication that is performed by multiplying the level of the L signal in each frequency band shown in FIG. 4C by the frequency-base filter factor for each frequency band shown in FIG. 4D.

In other words, the HPF processing by the HPF 102 can conceivably be equivalent to Equation (8):

Lc′(ƒ)=Ln (ƒ)×frequency—base filter factor (8)

where Ln(f) represents the frequency-base signal of the L signal for the conventional wind noise reduction apparatus 100, and Lc′(f) represents the frequency-base signal of the output L signal resultant from the HPF processing.

Therefore, for example, the L signals in the bands f1, f2 and f3 shown in FIG. 4C are subjected to processing as given by the following equations, by the HPF 102 shown in FIG. 1.

Lc′(ƒ1)=Ln(ƒ1)×0.2

Lc′(ƒ2)=Ln(ƒ2)×0.3

Lc′(ƒ3)=Ln(ƒ3)×0.6

On the other hand, if the wind noise is present, the filtering unit 5 shown in FIG. 2 according to the first example performs the processing using Equation (6).

Therefore, the L signals in the bands f1 and f2 are subjected to processing as given by the following equations, by the filtering unit 5.

Ln′(ƒ1)=Ln(ƒ1)^{0.8}

Ln′(ƒ2)=Ln(ƒ2)^{0.8}

For the band f3, the processing using Equation (4) rather than the processing using Equation (6) is performed, since the band f3 is a midrange frequency band of 1 kHz or more.

In other words, the processing is given by the following equation.

Ln′(ƒ3)=Ln(ƒ3)

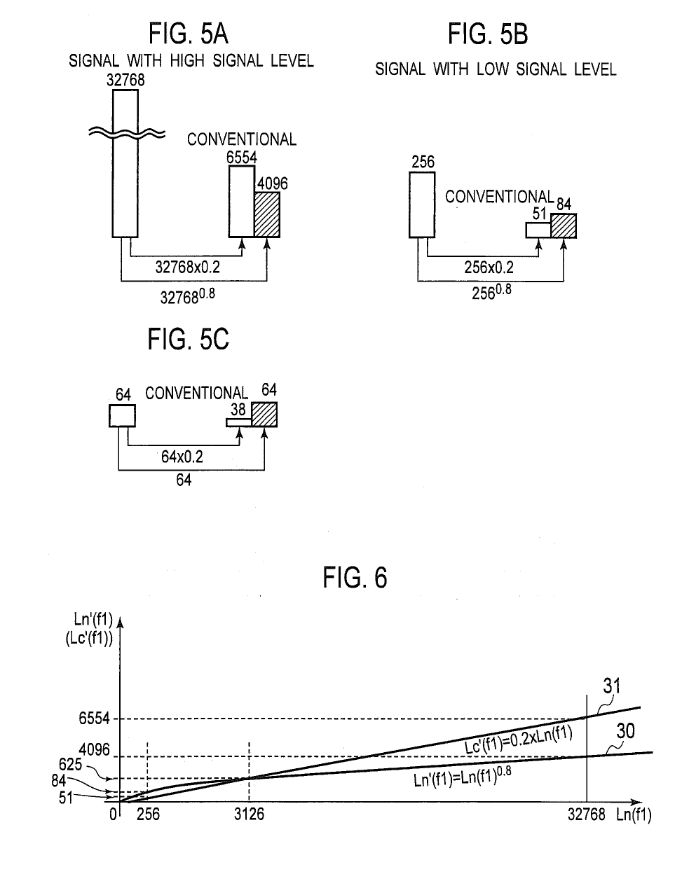

FIGS. 5A to 5C are diagrams explaining a difference in the effect of wind noise reduction between the conventional wind noise reduction apparatus 100 and the wind noise reduction apparatus 1 according to the first example, which is observed in a situation where a wind is strong and in a situation where a wind is not strong. Incidentally, FIGS. 5A to 5C show the level of the frequency-base L signal in the band fl.

FIG. 5A is the diagram showing a comparison of the effects in a situation where the wind noise is of very great magnitude, or equivalently, in a situation where the signal in the band f1 has a very high signal level of, for example, 32768 (Ln(ƒ1)=32768).

With the HPF 102 of the conventional wind noise reduction apparatus 100 (see FIG. 1), processing is performed as given by the following equation.

Ln′(ƒ1)=Ln(ƒ1)^{0.8}=(32768)^{0.8}=4096.

On the other hand, with the filtering unit 5 of the wind noise reduction apparatus 1 according to the first example, processing is performed as given by the following equation.

Ln′(ƒ1)=Ln (ƒ1)^{0.8}=(32768)^{0.8}=4096

In other words, the processing by the filtering unit 5 according to the first example enables making lower the levels of the audio signals in the frequency band f1, most of which can possibly be the wind noise, as compared to the processing by the HPF 102.

On the other hand, FIG. 5B is the diagram showing a comparison of the effects in a situation where the wind noise is small magnitude, or equivalently, in a situation where the signal in the band f1 has a low signal level of, for example, 256 (Ln(ƒ1)=256). In this situation, it is conceivable that the percentage of the wind noise contained in the audio signal in the band f1 is not very high as compared to that of the essentially required audio signal. Therefore, an excessive reduction in the level of the audio signal leads also to a reduction in the level of the essentially required audio signal, and thus, the degree of attenuation has to be small.

Here, with the HPF 102 of the conventional wind noise reduction apparatus 100 (see FIG. 1), processing is performed as given by the following equation.

Lc′(ƒ1)=Ln(ƒ1)×0.2=256×0.2≈51

On the other hand, with the filtering unit 5 of the wind noise reduction apparatus 1 according to the first example, processing is performed as given by the following equation, so that the degree of attenuation can become smaller.

Ln′(ƒ1)=Ln(ƒ1)^{0.8}=(256)^{0.8}≈84

Description will now be given with reference to a graph with regard to the effect of wind noise reduction according to the first example mentioned above.

FIG. 6 is a graph showing the relationship between Equation (6) for the wind noise reduction process according to the first example and Equation (8) for the conventional wind noise reduction process.

In FIG. 6, the horizontal axis indicates Ln(f1) that represents the level of the L signal in the band f1, and the vertical axis indicates any one of Ln′(f1) and Lc′(f1).

A curve 30 represents Lc′(ƒ1))=Ln(ƒ1)^{0.8}, and a straight line 31 represents Lc′(ƒ1)=Ln(ƒ1)×0.2.

Ln(f1) is approximately equal to 3126 (Ln(ƒ1)≈3126) at a point Q of intersection of the curve 30 and the straight line 31.

Therefore, if Ln(f1) exceeds 3126, the degree of wind noise reduction using Equation (6) is greater than the degree of wind noise reduction using Equation (8). On the other hand, if Ln(f1) is less than 3126, the degree of wind noise reduction using Equation (6) is smaller than the degree of wind noise reduction using Equation (8).

Therefore, the level of Ln(f1) has to be adjusted so that Ln(f1) exceeds 3126 (Ln(ƒ1)>3126), in order that the degree of wind noise reduction using Equation (6) is greater than the degree of wind noise reduction using Equation (8). Conversely, the level of Ln(f1) has to be adjusted so that Ln(f1) is less than 3126 (Ln(ƒ1)<3126), in order that the degree of wind noise reduction using Equation (6) is smaller than the degree of wind noise reduction using Equation (8).

FIG. 5C is the diagram showing a comparison of the effects of processing performed on the audio signal in the band f3 corresponding to a frequency band of 1 kHz or more, which is not affected much by the wind noise. If the audio signal in the band f3 has a signal level of, for example, 64 (Ln(ƒ3)=64), with the HPF 102 of the conventional wind noise reduction apparatus 100 (see FIG. 1), processing is performed as given by the following equation, resulting in a reduction in the signal level even though the signal is not affected much by the wind noise.

Lc′(ƒ3)=Ln(ƒ3)×0.6=64×0.6=38.4

On the other hand, with the filtering unit 5 of the wind noise reduction apparatus 1 according to the first example, processing is performed as given by the following equation, so that the signal level is not reduced.

Ln′(ƒ3)=Ln (ƒ3)=64

As described above, the apparatus according to the first example can achieve a great degree of wind noise reduction if the influence of the wind noise is very great, or conversely, the apparatus can achieve a small degree of wind noise reduction if the influence of the wind noise is not very great.

Also, the apparatus according to the first example is configured so as not to perform the wind noise reduction process on the audio signals in a frequency band of 1 kHz or more, thus eliminating a reduction in the levels of the audio signals in a frequency band of 1 kHz or more, which are not affected much by the wind noise.

Also, the apparatus according to the first example has the wind noise reduction filter factor fixedly set equal to 0.8 and thus enables achieving relatively simple circuitry for implementation in hardware, if the wind noise appears.

### Second Example

In the first example, the wind noise reduction filter factor α is set equal to 0.8 (α=0.8); however, in the second example, the wind noise analyzer 4 derives the wind noise reduction filter factor α based on the calculated correlation value K, as given by Equation (9).

α=0.8+0.2×K (9)

Therefore, the filtering units 5 and 6 use Equations (10) and (11) to generate Ln′(f) and Rn′(f), respectively.

Ln′(ƒ)=Ln (ƒ)^{0.8+0.2K} (10)

Rn′(ƒ)=Rn (ƒ)^{0.8+0.2K} (11)

In this instance, K approaches 0 as the wind noise that appears becomes greater in magnitude. In this case, Equations (10) and (11) approach Equations (6) and (7), respectively, according to the first example.

On the other hand, K approaches 1 as the wind noise that appears becomes smaller in magnitude. In this case, Equations (10) and (11) approach Equations (4) and (5), respectively, according to the first example.

Incidentally, also in this instance, Equations (10) and (11) are applied only to a frequency band of 1 kHz or less and are not applied to a frequency band of more than 1 kHz.

Also, Equation (9) derived may be transformed so that the wind noise reduction filter factor a increases as the frequency band changes from the low-frequency range to the high-frequency range.

According to the second example, a is derived based on the correlation value between the L signal and the R signal, thus enabling smooth wind noise reduction according to the magnitude of the wind noise.

### Third Example

Description will be given with regard to an embodiment of the present invention as applied to an imaging apparatus and an audio signal recording apparatus.

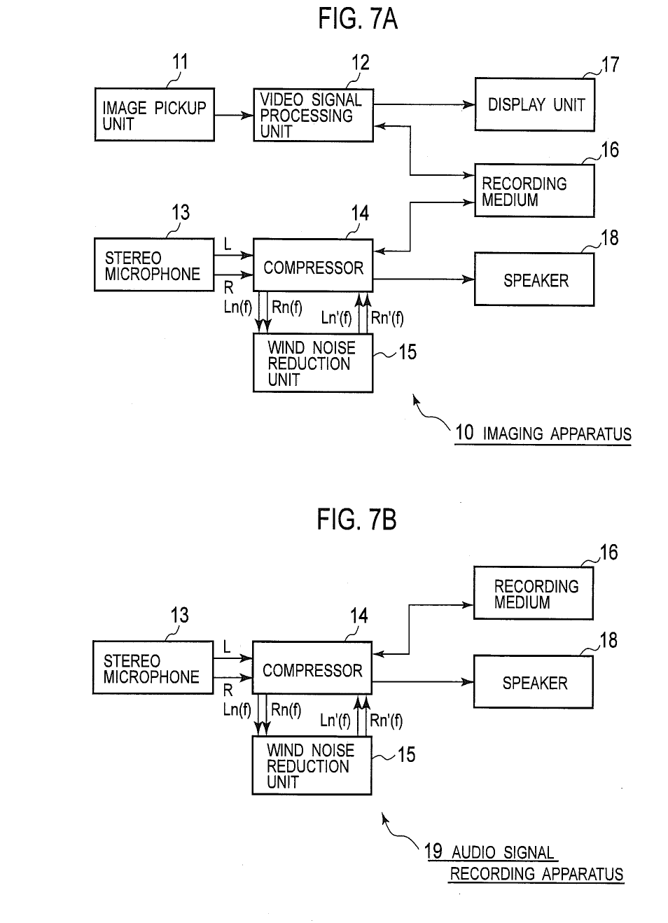

FIG. 7A is a general block diagram (or a functional block diagram) of an imaging apparatus 10. The imaging apparatus 10 is, for example, a digital video camera or the like. The imaging apparatus 10 is capable of moving and still picture taking and audio signal recording.

An image pickup unit 11 includes an optical system and an image pickup device such as a CCD (charge coupled device) image sensor or a CMOS (complementary metal oxide semiconductor) image sensor. The image pickup unit 11 converts an optical image entering through the optical system into an electric signal. A video signal processing unit 12 generates a video signal indicative of an image picked up by the image pickup unit 11, based on the electric signal, and also compresses the video signal by use of a predetermined compression method. For a moving picture, a compression method such as MPEG (Moving Picture Experts Group) is used for the compression of the video signal, while, for a still picture, a compression method such as JPEG (Joint Photographic Experts Group) is used for the compression of the video signal.

A compressor 14 generates an audio signal having desired characteristics, based on an output signal from a stereo microphone 13, and also performs a compressing process on the audio signal by use of a predetermined compression method.

FIG. 7A shows an instance where an AAC (advanced audio coding) encoder is used for the compressing process.

A wind noise reduction unit 15 is configured of the wind noise analyzer 4 and the filtering units 5 and 6 shown in FIG. 2.

The compressed video and audio signals are recorded on a recording medium 16 such as a memory card or an optical disk in accordance with operation on an operation unit (not shown) included in the imaging apparatus 10.

The compressor 14 outputs to the wind noise reduction unit 15 the frequency-base signals Ln(f) and Rn(f) of the L and R signals generated in the compressing process.

The wind noise reduction unit 15 performs the above-mentioned wind noise reduction process to thereby generate Ln′(f) and Rn′(f), which in turn are outputted and sent back to the compressor 14.

The compressor 14 subsequently performs the compressing process on Ln′(f) and Rn′(f), and the compressed audio signals are recorded on the recording medium 16.

FIG. 7B is a general block diagram (or a functional block diagram) of an audio signal recording apparatus 19. The audio signal recording apparatus 19 is, for example, an MD (MiniDisc) with recording capability, or the like.

Since blocks of the audio signal recording apparatus 19 are the same as those of the imaging apparatus 10, description thereof will be omitted. In the audio signal recording apparatus 19, however, only the compressed audio signal is recorded on the recording medium 16.

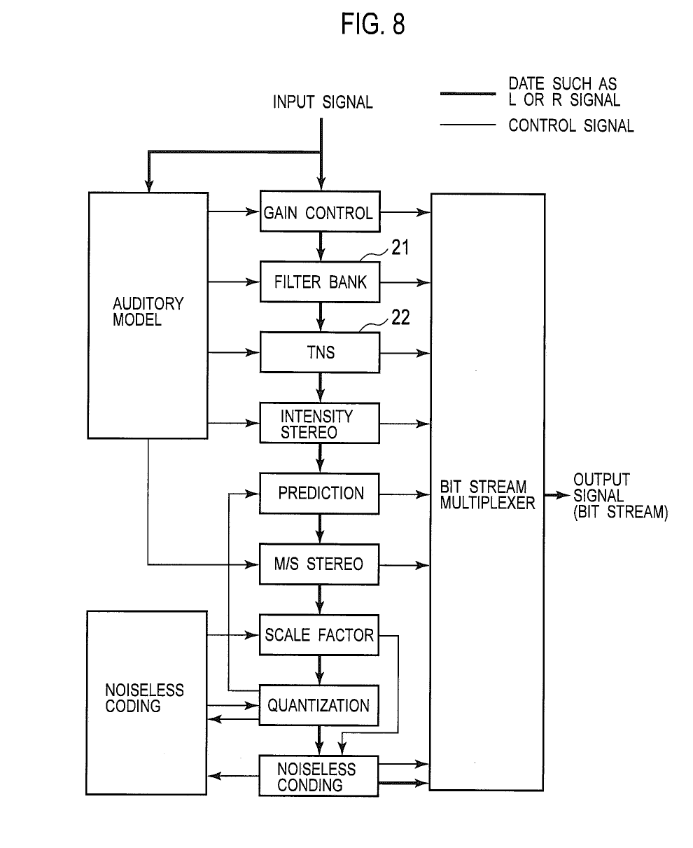

FIG. 8 shows an internal block diagram of the AAC encoder. Since parts of the AAC encoder operate in accordance with AAC standards, description of operation will be omitted. A filter bank 21 provided in the AAC encoder generates the frequency-base signals Ln(f) and Rn(f) through MDCT (modified discrete cosine transform). The wind noise reduction unit 15 performs the wind noise reduction process on Ln(f) and Rn(f) to thereby generate Ln′(f) and Rn′(f), which in turn are outputted and sent back to the AAC encoder.

After TNS 22, the AAC encoder performs the compressing process on Ln′(f) and Rn′(f).

The imaging apparatus according to the third example can record an audio signal subjected to appropriate wind noise reduction, for example even if moving picture taking is done outdoors on a windy day.

Also, an output from the AAC encoder can be utilized for the wind noise reduction process, and thus, this utilization contributes to hardware size reduction for implementation of the AAC encoder or the wind noise reduction unit 15 in hardware configuration. On the other hand, the utilization contributes to a reduction in the amount of processing by software (or equivalently, the amount of programs) for implementation in software.

By referring to the above-mentioned embodiment, the wind noise reduction apparatus 1 according to the present invention has been described as implemented in the imaging apparatus or the audio signal recording apparatus; however, besides the above, equipment with audio signal recording capability, such as an IC recorder or a mobile telephone, or the like may be used as the audio signal recording apparatus for application of the wind noise reduction apparatus.

Also, any one of a display unit 17 of the imaging apparatus 10 shown in FIG. 7A and a display unit (not shown in FIG. 7B) attached to the audio signal recording apparatus 19 shown in FIG. 7B may be used to display on the display unit a wind noise mark indicative of an index of the intensity of wind noise or an index of the degree of wind noise reduction by any one of the wind noise reduction apparatus 1 and the wind noise reduction unit 15.

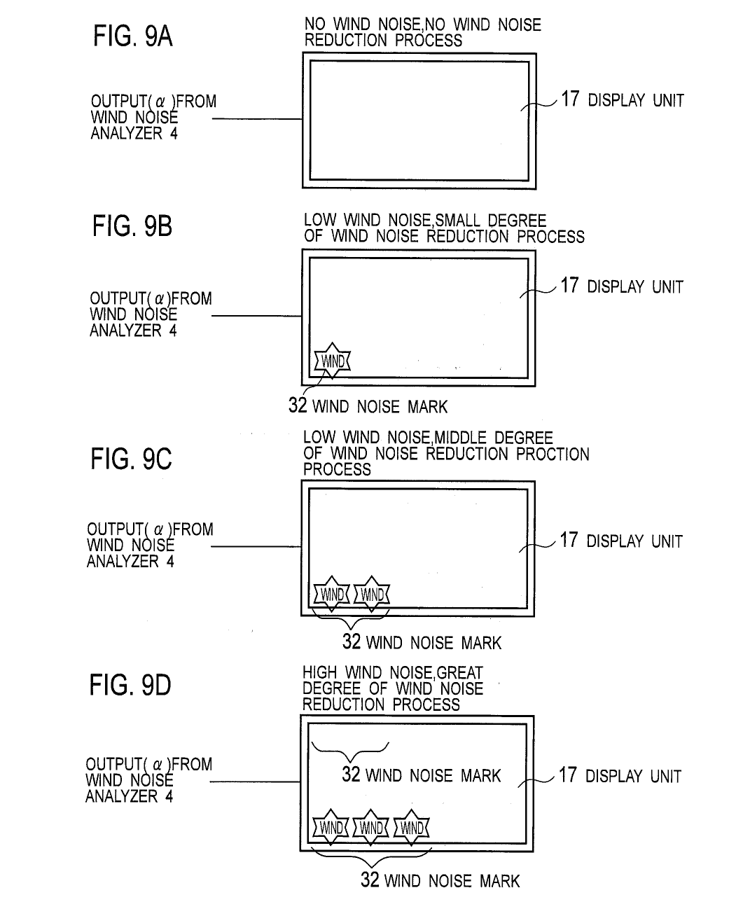

FIGS. 9A to 9D show an example of the wind noise mark displayed on the display unit 17 of the imaging apparatus 10 shown in FIG. 7A.

For example, the display unit 17 receives an input of the wind noise reduction filter factor a from the wind noise analyzer 4. At this point, if α is set equal to 1 (α=1), the wind noise reduction process does not take place. In this instance, a wind noise mark 32 is not displayed as shown in FIG. 9A.

For example, the wind noise marks 31 are displayed as shown in FIGS. 9B, 9C and 9D, according to an instance where a satisfies (0.7≦α<1), an instance where α satisfies (0.4≦α<0.7), and an instance where a satisfies (0<α<0.4), respectively. In other words, on the display unit 17, the number of wind noise marks 32 displayed increases as the wind noise reduction filter factor α from the wind noise analyzer 4 becomes smaller.

In this way, the wind noise reduction apparatus is able to provide a user with information on how large appearing wind noise is or how much the wind noise is reduced through processing.

What is claimed is:

1. A wind noise reduction apparatus for reducing wind noise contained in each of a plurality of audio signals by performing filtering on the plurality of audio signals, comprising:
a wind noise analyzer configured to derive a variable P (0<P≦1) corresponding to the degree of correlation between at least two of the plurality of audio signals, and
a filtering unit configured to perform the filtering, wherein
the filtering unit is configured to raise a function of frequency components of each of the plurality of audio signals to the Pth power.

2. The wind noise reduction apparatus according to claim 1, wherein the wind noise analyzer derives the variable P so that the variable P becomes larger as the degree of the correlation becomes higher.

3. The wind noise reduction apparatus according to claim 1, wherein the wind noise analyzer includes a decision unit configured to determine whether or not the wind noise is produced, based on the degree of the correlation, and
the wind noise analyzer sets the variable P to a predetermined value less than 1 if the decision unit determines that the wind noise is produced, or sets the variable P to 1 if the decision unit determines that the wind noise is not produced.

4. The wind noise reduction apparatus according to claim 1, wherein the filtering unit performs the filtering on frequencies lower than a predetermined frequency in an audio-frequency band.

5. An audio signal recording apparatus for reducing wind noise contained in each of a plurality of audio signals by performing filtering the plurality of audio signals, comprising:
a plurality of audio signal pickup units configured to pick up the plurality of audio signals, respectively;
a wind noise analyzer configured to derive a variable P (0<P≦1) corresponding to the degree of correlation between at least two of the plurality of audio signals, and
a filtering unit configured to perform the filtering, wherein
the filtering unit is configured to raise a function of frequency components of each of the plurality of audio signals to the Pth power.

6. The audio signal recording apparatus according to claim 5, further comprising a display unit configured to display a wind noise mark indicative of information on the wind noise according to the value of the variable P derived by the wind noise analyzer.

7. An imaging apparatus, comprising:
an image pickup unit configured to pick up an image of a subject; and
the audio signal recording apparatus according to claim 5.
